(19) United States
(12) Patent Application Publication
(10) Pub. No.: US 2011/0221417 A1
(43) Pub. Date: Sep. 15, 2011

(54) POWER SUPPLY APPARATUS AND POWER SUPPLY CONTROL METHOD

(75) Inventors: Katsutoshi ISHIDOH, Kawasaki (JP); Hironobu Hongo, Kawasaki (JP)

(73) Assignee: FUJITSU LIMITED, Kawasaki-shi (JP)

(21) Appl. No.: 13/018,715

(22) Filed: Feb. 1, 2011

(30) Foreign Application Priority Data
Mar. 11, 2010 (JP) 2010-55033

(51) Int. Cl. G05F 1/618

(52) U.S. Cl. 323/288

(57) ABSTRACT

A power supply apparatus includes a detector configured to detect a peak of a transmission signal, a determination unit configured to determine a timing when a change of a variable voltage which is output from the apparatus and which corresponds to the detected peak of the transmission signal is started in accordance with a voltage value corresponding to the peak and a change rate of the variable voltage, a generation unit configured to generate a variable voltage control signal used to start the change of the voltage at the determined timing, and an output unit configured to output a voltage in accordance with the generated variable voltage control signal.

### CROSS-REFERENCE TO RELATED APPLICATIONS

This application is based upon and claims the benefit of priority from the prior Japanese Patent Application No. 2010-55033 filed on Mar. 11, 2010, the entire contents of which are incorporated herein by reference.

### FIELD

The embodiment relates to a power supply apparatus and a power supply control method.

### BACKGROUND

In general wireless communication, a wireless apparatus generates electric waves of a certain frequency and transmits information in accordance with signals of carriers obtained by modulating the electric waves. The wireless apparatus which transmits and receives the signals of the carriers amplifies electric powers of signals to be transmitted. For example, the wireless apparatus amplifies RF (Radio Frequency) signals to be transmitted using a power amplifier.

In recent years, suppression of increase of power consumption caused by rapid increase of an amount of traffic is demanded. As a method for reducing electric power used to transmit signals from a wireless apparatus, envelope tracking is generally used. In the envelope tracking, power consumption is reduced by supplying a power supply voltage corresponding to amplitude of a transmission signal to be amplified by a power amplifier to the power amplifier. PCT Japanese Translation Patent Publication No. 2005-513943 and Japanese Unexamined Patent Application Publication No. 2004-173249 disclose examples of the related art utilizing the envelope tracking.

The related arts described above have a certain limit for reduction of power consumption. In the related arts described above, when an electric power of a signal to be transmitted is amplified, a fixed voltage to be supplied to the power amplifier is changed in accordance with the amplitude of the transmission signal. Accordingly, when an amount of the amplitude and a value of the fixed voltage are considerably different from each other, an excessive amount of electric power is supplied in the related arts.

FIG. 21 is a diagram illustrating fixed voltages applied in accordance with a transmission signal. In FIG. 21, an axis of ordinate denotes a voltage and an axis of abscissa denotes time. FIG. 21 shows losses of electric powers generated when a transmission signal is amplified by changing a voltage value of a fixed voltage every 0.5 V applied to an envelope of the transmission signal. The shaded regions shown in FIG. 21 denote losses of electric powers.

For example, in the related arts described above, as shown in FIG. 21, a voltage of 1.0 V is supplied first to a first peak. Thereafter, when an envelope of a transmission signal excesses a voltage of 1.0 V, a voltage of 1.5 V is supplied. Then, in the related arts described above, when the envelope of the transmission signal becomes equal to or smaller than the voltage of 1.0 V, a voltage of 1.0 V is supplied. By this, in the related arts described above, the fixed voltage to be supplied is changed so that the transmission signal is amplified. Accordingly, as portions denoted by ovals shown in FIG. 21, when the fixed voltage is higher than a peak of the transmission signal, an excessive amount of electric power is supplied, and accordingly, a loss of the electric power is generated. Consequently, power consumption of the power amplifier is not efficiently reduced.

### SUMMARY

According to an aspect of an embodiment, a power supply apparatus includes a detector configured to detect a peak of a transmission signal, a determination unit configured to determine a timing when a change of a variable voltage which is output from the apparatus and which corresponds to the detected peak of the transmission signal is started in accordance with a voltage value corresponding to the peak and a change rate of the variable voltage, a generation unit configured to generate a variable voltage control signal used to start the change of the voltage at the determined timing, and an output unit configured to output a voltage in accordance with the generated variable voltage control signal.

The object and advantages of the various embodiments will be realized and attained by at least the elements, features, and combinations particularly pointed out in the claims. It is to be understood that both the foregoing general description and the following detailed description are exemplary and explanatory and are not restrictive of the various embodiments, as claimed.

Additional aspects and/or advantages will be set forth in part in the description which follows and, in part, will be apparent from the description, or may be learned by practice of the various embodiments.

### BRIEF DESCRIPTION OF THE DRAWINGS

FIG. 1 is a diagram illustrating a configuration of a power supply apparatus according to a first embodiment;

FIG. 2 is a diagram illustrating a configuration of a power supply circuit according to a second embodiment;

FIG. 3 is a diagram illustrating a variable voltage source of the power supply circuit according to the second embodiment;

FIG. 4 is a diagram illustrating a configuration of a digital processor of the power supply circuit according to the second embodiment;

FIGS. 5A to 5D are graphs illustrating generation of a variable voltage corresponding to a largest voltage value;

FIGS. 6A to 6D are graphs illustrating generation of a variable voltage corresponding to a voltage value smaller than the largest voltage value;

FIG. 7 is a timing chart of the digital processor of the power supply circuit according to the second embodiment;

FIG. 8 is a flowchart illustrating a procedure of a process performed by the power supply circuit according to the second embodiment;

FIG. 9 is a flowchart illustrating a procedure of a variable voltage generation process performed by the digital processor of the power supply circuit according to the second embodiment;

FIG. 10 is a diagram illustrating a result of simulation performed by the power supply circuit according to the second embodiment;

FIG. 11 is a diagram illustrating reduction of power consumed by the power supply circuit according to the second embodiment;

FIG. 12 is a diagram illustrating a power supply circuit according to a third embodiment;

FIG. 13 is a diagram illustrating a configuration of a digital processor of the power supply circuit according to the third embodiment;

FIG. 14 is a flowchart illustrating a procedure of a process performed by the power supply circuit according to the third embodiment;

FIG. 15 is a flowchart illustrating a procedure of a variable voltage generation process performed by the digital processor of the power supply circuit according to the third embodiment;

FIG. 16 is a diagram illustrating a result of simulation performed by the power supply circuit according to the third embodiment;

FIG. 17 is a diagram illustrating a configuration of a digital processor of a power supply circuit according to a fourth embodiment;

FIG. 18 is a timing chart illustrating the digital processor of the power supply circuit according to the fourth embodiment;

FIG. 19 is a flowchart illustrating a procedure of a variable voltage generation process performed by the digital processor of the power supply circuit according to the fourth embodiment;

FIG. 20 is a diagram illustrating a modification; and

FIG. 21 is a diagram illustrating fixed voltages for a transmission signal.

### DESCRIPTION OF EMBODIMENTS

Embodiments of a power supply apparatus and a power supply control method disclosed in this application will be described in detail hereinafter with reference to the accompanying drawings. Note that the power supply apparatus and the power supply control method disclosed in this application are not limited to the embodiments below.

### First Embodiment

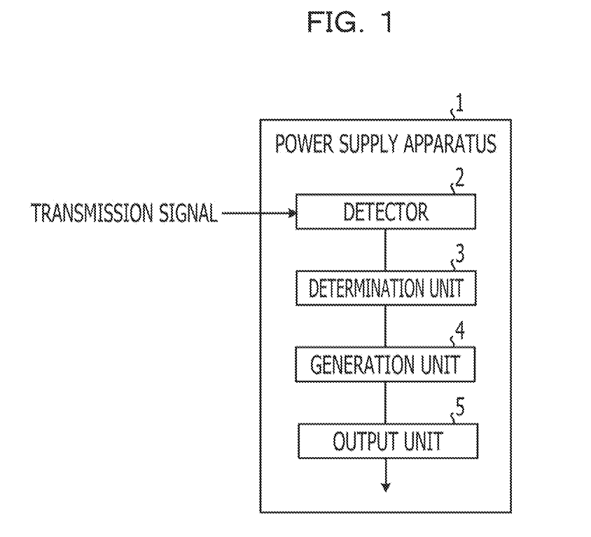

A configuration of a power supply apparatus according to a first embodiment will be described. FIG. 1 is a diagram illustrating the configuration of the power supply apparatus according to the first embodiment. As shown in FIG. 1, a power supply apparatus 1 includes a detector 2, a determination unit 3, a generation unit 4, and an output unit 5. The power supply apparatus 1 generates a variable voltage.

The detector 2 detects a peak of a transmission signal. The determination unit 3 determines a timing when a change of a variable voltage output from the apparatus for the peak of the transmission signal detected by the detector 2 is started in accordance with a voltage value relative to the peak and a change rate of the variable voltage output from the apparatus. The generation unit 4 generates a variable voltage control signal used to start a change of a voltage at a timing determined by the determination unit 3. The output unit 5 outputs a voltage in accordance with the variable voltage control signal generated by the generation unit 4.

As described above, the power supply apparatus 1 according to the first embodiment determines a timing when a change of a variable voltage is started in accordance with a peak of a transmission signal and a change rate of the variable voltage output from the power supply apparatus 1 and outputs the variable voltage at the determined timing. Accordingly, the power supply apparatus 1 of the first embodiment efficiently reduces power consumption by supplying a voltage corresponding to the peak to the power amplifier.

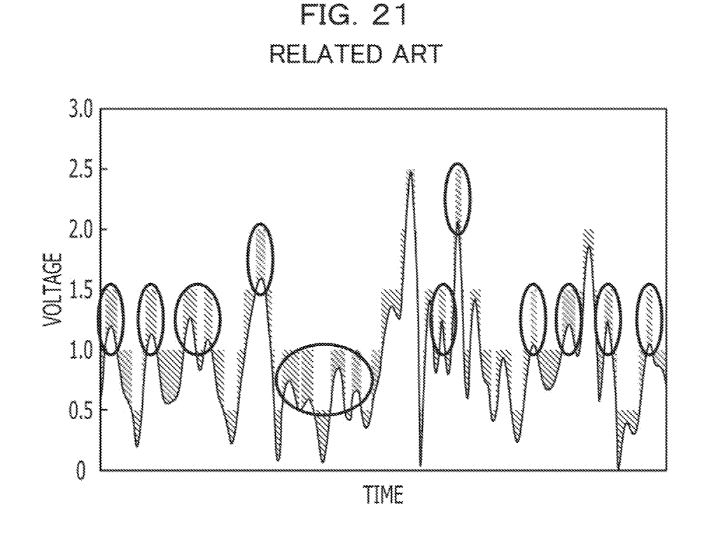

For example, the power supply apparatus 1 according to the first embodiment suppresses an excessive amount of electric power supplied to the portions denoted by the ovals in FIG. 21 and efficiently reduces power consumption by supplying a voltage corresponding to the peak to the power amplifier.

### Second Embodiment

Configuration of Power Supply Circuit of Second Embodiment

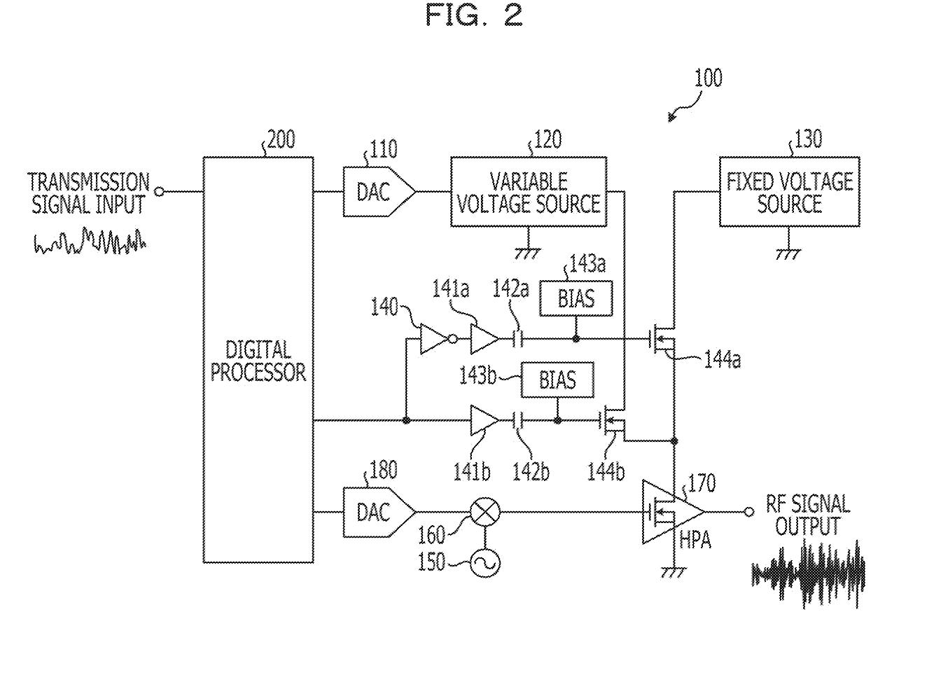

In a second embodiment, a case where a power supply circuit is used as a power supply apparatus will be described as an example. FIG. 2 is a diagram illustrating a configuration of a power supply circuit 100 according to the second embodiment. As shown in FIG. 2, the power supply circuit 100 includes a DAC (Digital Analog Converter) 110, a variable voltage source 120, a fixed voltage source 130, an inverter 140, amplifiers 141a and 141b, and capacitors 142a and 142b. The power supply circuit 100 further includes BIASs 143a and 143b, FETs (Field Effect Transistors) 144a and 144b, an oscillator 150, a multiplier 160, an HPA (High Power Amplifier) 170, and a DAC 180 as shown in FIG. 2. The power supply circuit 100 includes a digital processor 200 and outputs an RF signal obtained by amplifying an input transmission signal.

The DAC 110 converts a variable voltage control signal which is a digital signal generated by the digital processor 200 which will be described below into an analog signal. The variable voltage control signal is used to control a variable voltage. The variable voltage source 120 outputs a variable voltage in response to the variable voltage control signal supplied from the DAC 110. For example, the variable voltage source 120 outputs a variable voltage which is changed with a certain change rate in response to the variable voltage control signal. Note that the change rate may be referred to as a “through rate” hereinafter. The certain change rate means an amount of change of a voltage per unit time.

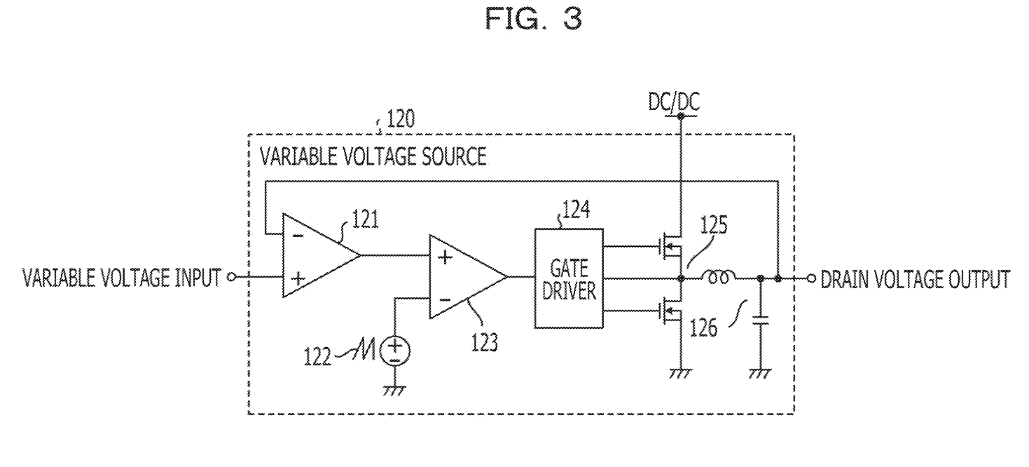

FIG. 3 is a diagram illustrating the variable voltage source 120 of the power supply circuit 100 according to the second embodiment. As shown in FIG. 3, the variable voltage source 120 includes an error amplifier 121, a reference oscillator 122, a comparator 123, a gate driver 124, an FET 125, and an LC filter 126.

The error amplifier 121 amplifies a difference between a variable voltage supplied from the DAC 110 and a variable voltage to be output from the variable voltage source 120 and outputs the amplified signal to the comparator 123. The reference oscillator 122 oscillates a reference signal and outputs the oscillated reference signal to the comparator 123. The comparator 123 compares the signal supplied from the error amplifier 121 with the reference signal and outputs a pulse signal on the basis of a result of the comparison to the gate driver 124.

The gate driver 124 controls the FET 125 in accordance with the pulse signal supplied from the comparator 123. The FET 125 controls a voltage value to be supplied to the LC filter 126 under control of the gate driver 124. The LC filter 126 smoothes the variable voltage supplied through the FET 125 and outputs the smoothed variable voltage as a drain voltage. Note that, in FIG. 3, a switching power supply source is used as the variable voltage source 120 of the second embodiment. However, the variable voltage source 120 is not limited to this, and any source device may be used as long as the source device amplifies a variable voltage signal so as to have a desired voltage and a desired current. Furthermore, when a power supply source other than the switching power supply source is employed, the power supply source preferably attains efficiency of a degree substantially the same as that of voltage supply efficiency of a fixed voltage source.

Referring back to FIG. 2, the fixed voltage source 130 outputs a voltage having a certain voltage value. The inverter 140 inverts a power supply switching signal generated by the digital processor 200 which will be described hereinafter. The power supply switching signal is used to perform switching between a fixed voltage and a variable voltage. For example, the inverter 140 inverts “0” and “1” of the power supply switching signal generated by the digital processor 200 from one to another.

The amplifier 141a amplifies the power supply switching signal which has been inverted by the inverter 140. The amplifier 141b amplifies the power supply switching signal generated by the digital processor 200 which will be described hereinafter. AC coupling capacitors serve as the capacitors 142a and 142b.

The BIAS 143a controls a gate bias of a signal output from the capacitor 142a. The BIAS 143b controls a gate bias of a signal output from the capacitor 142b. The FET 144a controls a voltage output from the fixed voltage source 130 in accordance with the power supply switching signal supplied through the capacitor 142a. For example, the FET 144a performs control so that a voltage output from the fixed voltage source 130 is supplied to the HPA 170 when receiving a power supply switching signal of “1” through the capacitor 142a.

The FET 144b controls a voltage output from the variable voltage source 120 in accordance with the power supply switching signal supplied through the capacitor 142b. For example, the FET 144b performs control so that a voltage output from the variable voltage source 120 is supplied to the HPA 170 when receiving a power supply switching signal of “1” through the capacitor 142b.

The DAC 180 converts a transmission signal which is a digital signal and which is output from the digital processor 200 which will be described hereinafter into an analog signal. The oscillator 150 generates a carrier. The multiplier 160 modulates the carrier generated by the oscillator 150 using the transmission signal supplied through the DAC 180. The HPA 170 amplifies the carrier which has been modulated by the multiplier 160 using the fixed voltage supplied through the FET 144a from the fixed voltage source 130 and the variable voltage supplied through the FET 144b from the variable voltage source 120. Then, the HPA 170 outputs the amplified carrier to an antenna not shown.

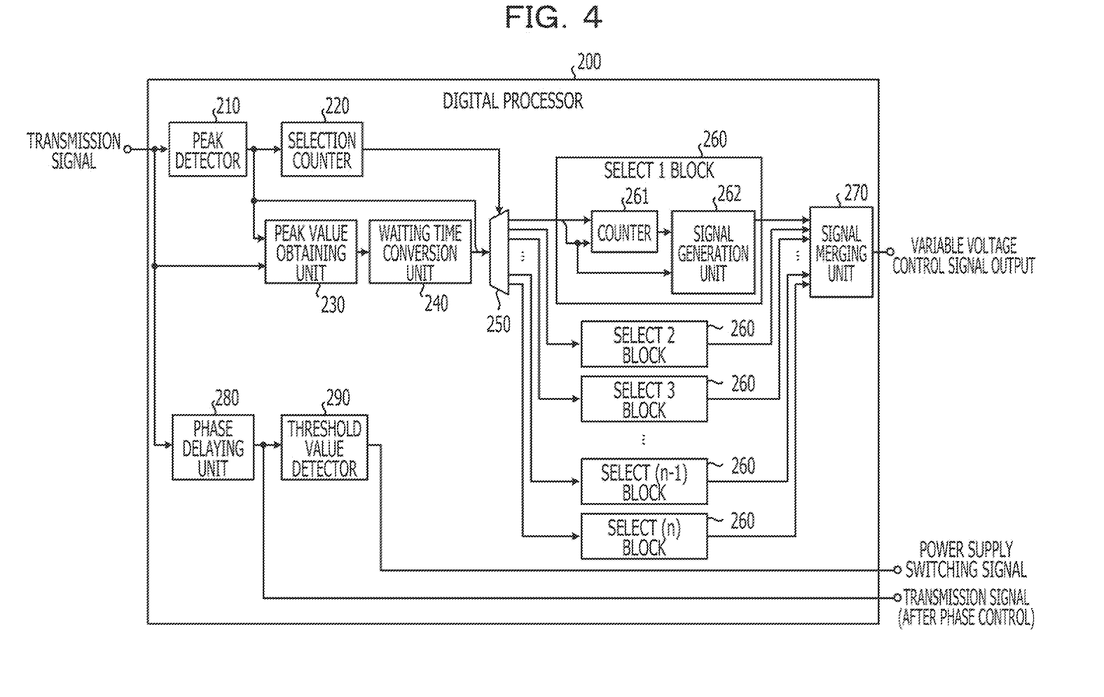

The digital processor 200 performs a process of generating a variable voltage control signal and a power supply switching signal in accordance with an input transmission signal. An integrated circuit such as an ASIC (Application Specific Integrated Circuit) or an FPGA (Field Programmable Gate Array) or an electronic circuit such as a CPU (Central Processing Unit) or an MPU (Micro Processing Unit) serves as the digital processor 200, for example. Hereinafter, referring to FIG. 4, a configuration of the digital processor 200 of the power supply circuit 100 according to the second embodiment will be described. FIG. 4 is a diagram illustrating a configuration of the digital processor 200 of the power supply circuit 100 according to the second embodiment.

Configuration of Digital Processor of Power Supply Circuit of Second Embodiment

As shown in FIG. 4, the digital processor 200 of the second embodiment includes a peak detector 210, a selection counter 220, a peak value obtaining unit 230, a waiting time conversion unit 240, and a selector 250. The digital processor 200 further includes a select1-block 260 to a select(n)-block 260, a signal merging unit 270, a phase delaying unit 280, and a threshold value detector 290.

The peak detector 210 detects peaks of a transmission signal. For example, the peak detector 210 detects peaks having a value equal to or larger than a peak value which has been arbitrarily set. For example, the peak detector 210 detects peaks having a value equal to or larger than the smallest voltage value of the variable voltage source 120.

The selection counter 220 increments a count number by 1 when the peak detector 210 detects a peak of a transmission signal. The peak value obtaining unit 230 obtains and stores a peak value of a peak detected by the peak detector 210. The waiting time conversion unit 240 determines a timing when a change of a variable voltage corresponding to the peak is started in accordance with a peak value of the peak detected by the peak detector 210 and a change rate of a variable voltage output from the apparatus.

For example, the waiting time conversion unit 240 determines a waiting time which is a period of time from when the peak is detected to when a change of the variable voltage is started using the peak value stored in the peak value obtaining unit 230 and the through rate of the variable voltage output from the variable voltage source 120. Here, a processing time for generating a variable voltage will be described. In this embodiment, the processing time for generating a variable voltage means a period of time from when a change of a variable voltage for a peak of a transmission signal is started to when the change of the variable voltage is terminated.

The processing time for a variable voltage varies depending on a peak value since a through rate of a variable voltage output from the variable voltage source 120 is constant. The processing time for a variable voltage is calculated in accordance with Equation (1) below. In Equation (1), “T[sec]” denotes the processing time for a variable voltage, and “Vₚ₋ₚ[V]” denotes a voltage for a peak. Furthermore, “SR[V/sec]” denotes a through rate of a variable voltage output from the variable voltage source 120.

$$T [ sec ] = \frac{{V}_{p - p} [ V ]}{SR [ V \text{/} sec ]} \times 2 \qquad ( 1 )$$

That is, the processing time for a variable voltage is obtained by, as shown by Expression (1), adding a period of time in which a variable voltage rises to a voltage corresponding to a peak value and a period of time in which the variable voltage falls to an original voltage after reaching the voltage corresponding to the peak value to each other. Accordingly, the processing time for a variable voltage becomes the largest when the voltage value corresponding to the peak value corresponds to the largest voltage value of the variable voltage source 120.

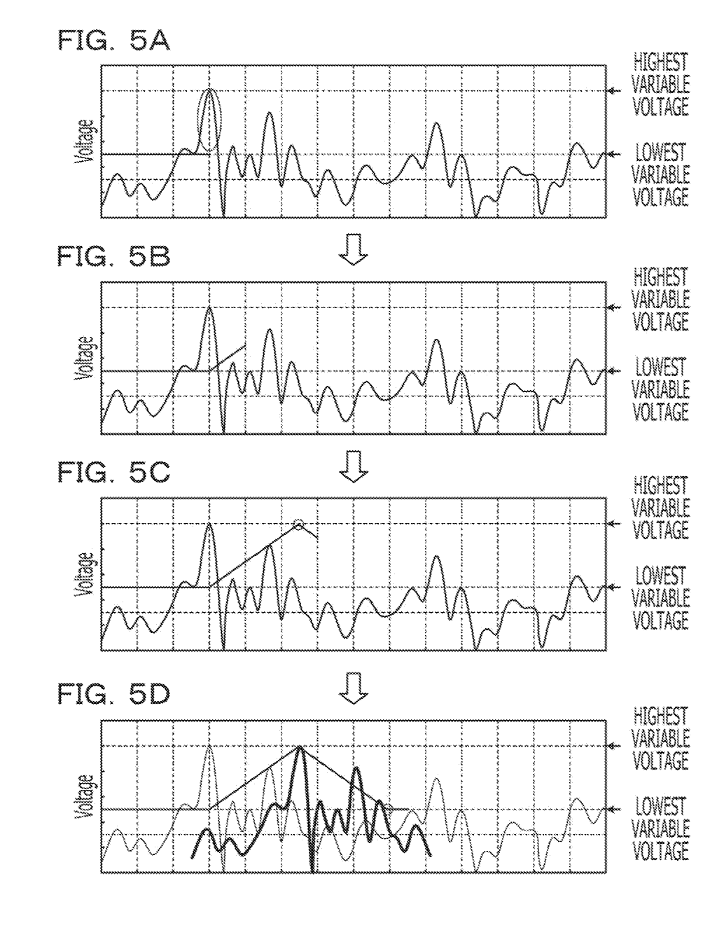

FIGS. 5A to 5D are graphs illustrating generation of a variable voltage corresponding to a largest voltage value. In FIGS. 5A to 5D, axes of ordinate denote a voltage and axes of abscissa denote time. FIGS. 5A to 5D show an envelope of a transmission signal and show a case where a voltage value corresponding to a peak value of the envelope corresponds to the largest voltage value of a variable voltage. The variable voltage source 120 supplies a voltage corresponding to a peak larger than the smallest variable voltage. If a voltage corresponding to a peak of a transmission signal is smaller than the smallest variable voltage, the fixed voltage source 130 supplies a fixed voltage.

When the largest variable voltage is to be output corresponding to a peak of an envelope as denoted by an oval shown in FIG. 5A, the variable voltage rises with a certain through rate from a time point when the peak is detected as shown in FIG. 5B. Then, as denoted by a circle shown in FIG. 5C, when reaching the highest voltage, the variable voltage is reduced with a through rate the same as that at the time when the variable voltage rose. Then, as denoted by a circle shown in FIG. 5D, when the variable voltage has reached the lowest voltage, a change of the variable voltage is terminated. Accordingly, when the largest variable voltage is to be output for a peak of an envelope, a period of time required for generating the variable voltage corresponds to a period of time from when the peak is detected to when a change of the variable voltage is terminated.

The processing time for generation of a variable voltage varies depending on a peak. Accordingly, a waiting time is provided with reference to a period of time required for outputting the highest voltage in order to match a position of a peak with a position of a voltage for the peak when a voltage value for the peak is smaller than the highest voltage.

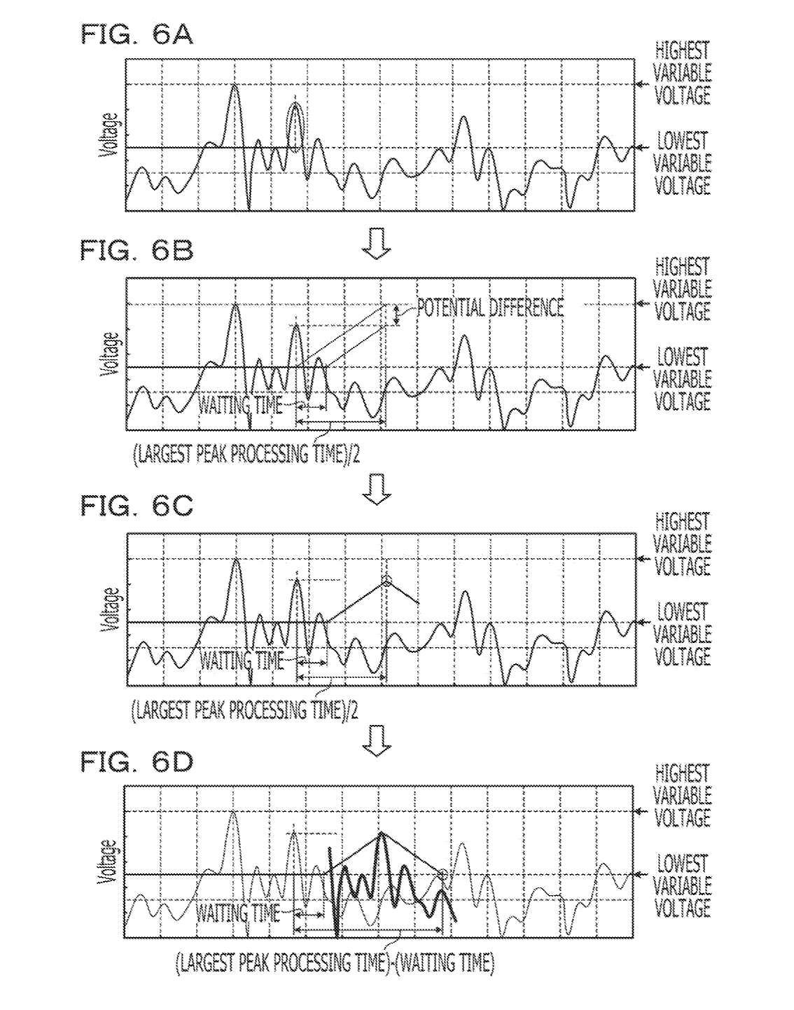

FIGS. 6A to 6D are graphs illustrating generation of a variable voltage corresponding to a voltage value smaller than the largest voltage value. In FIGS. 6A to 6D, axes of ordinate denote a voltage and axes of abscissa denote time. FIGS. 6A to 6D show an envelope of a transmission signal and a case where a voltage value corresponding to a peak value of the envelope is smaller than the largest voltage value of the variable voltage. As denoted by an oval in FIG. 6A, when a voltage smaller than the largest voltage value is to be output relative to a peak of the envelope, as shown in FIG. 6B, a change of the variable voltage is started after a waiting time is elapsed from a time point when the peak is detected. The time point when the change of the variable voltage is started is determined, as shown in FIG. 6B, such that when the voltage is raised relative to the peak, the voltage reaches a target voltage value at a time point corresponding to half of a largest peak processing time which is a processing time of the highest voltage.

That is, after the period of time required for attaining a certain potential difference between the largest voltage value and a raised voltage is waited as shown in FIG. 6B, a change of the variable voltage smaller than the largest voltage value is started. The waiting time conversion unit 240 determines a waiting time in accordance with Expression (2) below. In Expression (2), “T_{w}[sec]” denotes a waiting time, “Vₘₐₓ[V]” denotes the largest voltage value, and “Vₚ₋ₚ[V]” denotes a voltage corresponding to a peak. Furthermore, “SR[V/sec]” denotes a through rate of a variable voltage output from the variable voltage source 120.

$${T}_{w} [ sec ] = \frac{{V}_{max} [ V ] - {V}_{p - p} [ V ]}{SR [ V \text{/} sec ]} \times 2 \qquad ( 2 )$$

After the waiting time, which is determined by the waiting time conversion unit 240 in accordance with Expression (2), has elapsed after the peak is detected, when the variable voltage rises to a target voltage, the variable voltage falls with a through rate the same as that obtained when the variable voltage rose as denoted by a circle shown in FIG. 6C. Then, as denoted by a circle in FIG. 6D, the change of the variable voltage is terminated when the variable voltage has reached the lowest voltage.

In FIG. 4, the selector 250 transmits information on the detection of the peak and the waiting time to any one of the select1-block 260 to the select(n)-block 260 in accordance with the count number stored in the selection counter 220. Specifically, the selector 250 assigns information on a detection of a peak and a waiting time to one of the select1-block 260 to the select(n)-block 260 for each peak of the transmission signal.

The select1-block 260 includes, as shown in FIG. 4, a counter 261 and a signal generation unit 262 and generates a variable voltage control signal used to start a change of a voltage at a timing determined by the waiting time conversion unit 240. Each of the select2-block 260 to the select(n)-block 260 also includes the counter 261 and the signal generation unit 262 as well as the select1-block 260, though not shown in FIG. 4.

The counter 261 counts the largest peak processing time using the information on the detection of the peak supplied from the selector 250 as a trigger. The signal generation unit 262 refers to the counter 261 and starts generation of a variable voltage control signal used to control a change of a variable voltage after the waiting time input by the selector 250 is elapsed. For example, the signal generation unit 262 generates a variable voltage control signal used to raise a voltage after the waiting time has been elapsed whereas the signal generation unit 262 generates a variable voltage control signal used for voltage fall when a period of time measured by the counter 261 has reached half of the largest peak processing time. Note that the counter 261 and the signal generation unit 262 included in each of the select2-block 260 to the select(n)-block 260 perform the same processing as described above.

The signal merging unit 270 merges variable voltage control signals generated by the select1-block 260 to the select(n)-block 260 for individual peaks so as to output a single signal. The phase delaying unit 280 delays a phase of the transmission signal so that the peak of the variable voltage control signal and the peak of the transmission signal coincide with each other and outputs the delayed transmission signal. For example, the phase delaying unit 280 delays the phase of the transmission signal so that a portion of the variable voltage in which a rising state is changed to a falling state matches the peak of the transmission signal as shown in FIGS. 5D and 6D. For example, the phase delaying unit 280 delays the phase of the transmission signal for a period of time corresponding to half of the largest peak processing time.

The threshold value detector 290 determines whether a peak of the transmission signal is larger than a threshold value and outputs a result of the determination as a power supply switching signal. For example, the threshold value detector 290 determines whether a peak of the transmission signal is larger than the threshold value in order to determine whether a fixed voltage or a variable voltage is supplied relative to the peak of the transmission signal. For example, the threshold value detector 290 determines whether a voltage supplied relative to the peak is larger than the lowest voltage of the variable voltage source 120.

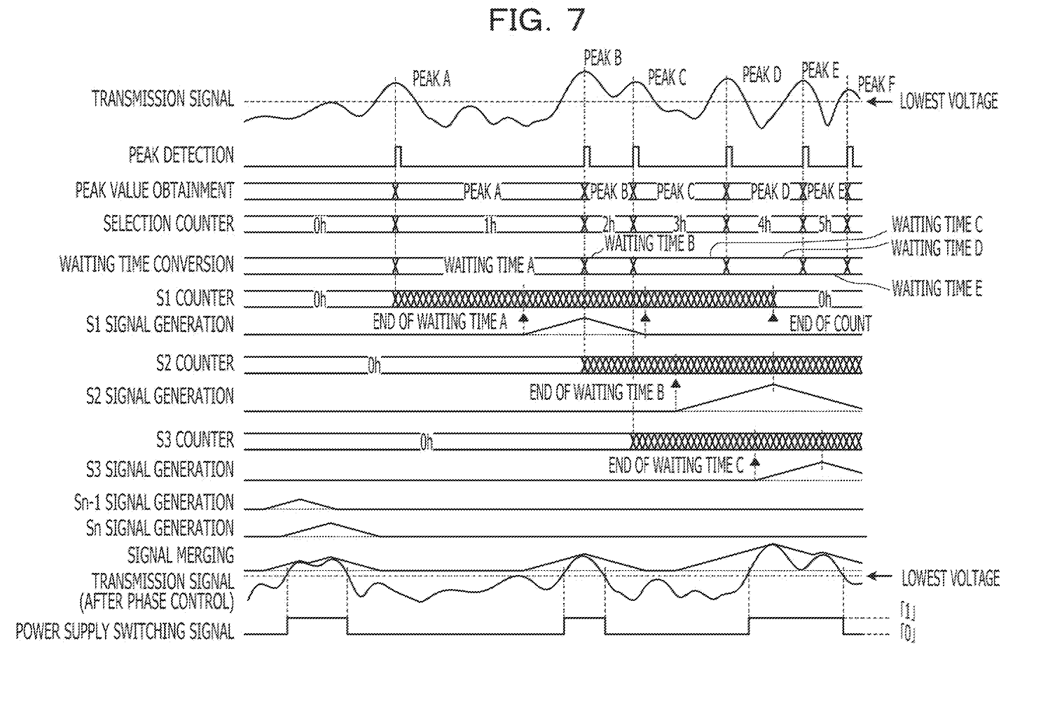

FIG. 7 is a timing chart of the digital processor 200 of the power supply circuit 100 according to the second embodiment. In FIG. 7, an axis of abscissa denotes time. In FIG. 7, “transmission signal” represents a data signal supplied to the digital processor 200, and “peak detection” represents the peak detector 210. Furthermore, “peak value obtainment” represents the peak value obtaining unit 230 and “selection counter” represents the selection counter 220. Moreover, “waiting time conversion” represents the waiting time conversion unit 240, “S1 counter” represents the counter 261 included in the select1select1-block 260, and “S1 signal generation” represents the signal generation unit 262 included in the select1-block 260.

Furthermore, “S2 counter” represents the counter 261 included in the select2-block 260, and “S2 signal generation” represents the signal generation unit 262 included in the select2-block 260. Moreover, “S3 counter” represents the counter 261 included in the select3-block 260, and “S3 signal generation” represents the signal generation unit 262 included in the select3-block 260.

In addition, “Sₙ₋₁ signal generation” represents the signal generation unit 262 included in the select(n-1)-block 260, and “Sₙ signal generation” represents the signal generation unit 262 included in the select(n)-block 260. Furthermore, “signal merging” represents the signal merging unit 270, “transmission signal” shown below “signal merging” represents a transmission signal which has been subjected to phase delay control performed by the phase delaying unit 280, and “power supply switching signal” represents a signal which is generated by the threshold value detector 290 and which is used to switch a fixed voltage and a variable voltage from one to another.

For example, when the transmission signal shown in FIG. 7 is supplied to the digital processor 200, the peak detector 210 detects, as shown in FIG. 7, peaks A to F of the transmission signal corresponding to voltages higher than the lowest voltage of the variable voltage source 120 and outputs signals corresponding to the peaks. When the peak detector 210 detects the peaks, the peak value obtaining unit 230 obtains values of the detected peaks. For example, the peak value obtaining unit 230 obtains values of the peaks A to E obtained by the peak detector 210 as shown in FIG. 7. Note that, although not shown, the peak value obtaining unit 230 also obtains a value of the peak F.

When the peak detector 210 detects a peak, the selection counter 220 increments a count number by 1. For example, as shown in FIG. 7, when the peak detector 210 detects the peak A, the selection counter 220 increments a count number from “0h” to “1h”. Similarly, every time the peak detector 210 detects one of the peaks B to E, the selection counter 220 increments the count number by 1.

When the peak value obtaining unit 230 obtains a peak value, the waiting time conversion unit 240 determines a waiting time in accordance with the obtained peak value. For example, when the peak value obtaining unit 230 obtains the value of the peak A, the waiting time conversion unit 240 determines a waiting time A which is a waiting time for the peak A. Similarly, every time the peak value obtaining unit 230 obtains one of values of the peak B to E, the waiting time conversion unit 240 determines a corresponding one of waiting times B to E. Note that “waiting time A” to “waiting time E” shown in FIG. 7 represent determined waiting times for the peaks A to E.

The counter 261 of the select1select1-block 260 starts measuring the largest peak processing time using the peak detection performed by the peak detector 210 as a trigger. For example, the counter 261 of the select1-block 260 starts measuring the largest peak processing time when the peak A is detected as represented by “S1_counter” in FIG. 7. The signal generation unit 262 of the select1-block 260 refers to the time measured by the counter 261 of the select1-block 260 and generates a rising variable voltage control signal shown as “S1_signal generation” in FIG. 7 after the waiting time A is terminated. Then, the signal generation unit 262 of the select1-block 260 generates a falling variable voltage control signal shown as “S1_signal generation” in FIG. 7 after a period of time corresponding to half of the largest peak processing time has been elapsed.

The counter 261 and the signal generation unit 262 of the select2-block 260 similarly performs the process using the peak B detected by the peak detector 210 as a trigger as shown in FIG. 7. Furthermore, the counter 261 and the signal generation unit 262 of the select3-block 260 similarly performs the process using the peak C detected by the peak detector 210 as a trigger as shown in FIG. 7. In FIG. 7, variable control signals shown as “Sₙ₋₁ signal generation” and “Sₙ signal generation” are generated so as to correspond to peaks detected before the peak A appears. Specifically, the select1-block 260 to the select(n)-block 260 successively perform the process for the peaks detected by the peak detector 210.

Then, when the variable voltage control signals for the peaks of the transmission signal are generated, the signal merging unit 270 merges the variable voltage control signals generated by the signal generation units 262 of the select1-block 260 to the select(n)-block 260 so as to obtain a single signal. The phase delaying unit 280 delays a phase of the transmission signal so that peaks of the single variable voltage control signal converted by the signal merging unit 270 coincides with the peaks of the transmission signal. The threshold value detector 290 refers to the transmission signal in which the phase thereof is delayed by the phase delaying unit 280 and generates signals representing peaks corresponding to voltages larger than the lowest voltage of the variable voltage source 120 as power supply switching signals. For example, as represented by “power supply switching signal” in FIG. 7, the threshold value detector 290 generates a power supply switching signal representing “1” in a period in which a voltage corresponding to a peak exceeds the lowest voltage and a power supply switching signal representing “0” in a period in which a voltage corresponding to a peak is smaller than the lowest voltage.

Hereinafter, a process performed by the power supply circuit 100 according to the second embodiment will be described. First, a procedure of a process performed by the power supply circuit 100 according to the second embodiment will be described. Thereafter, a procedure of a process performed by the digital processor 200 included in the power supply circuit 100 according to the second embodiment will be described.

Procedure of Process Performed by Power Supply Circuit of Second Embodiment

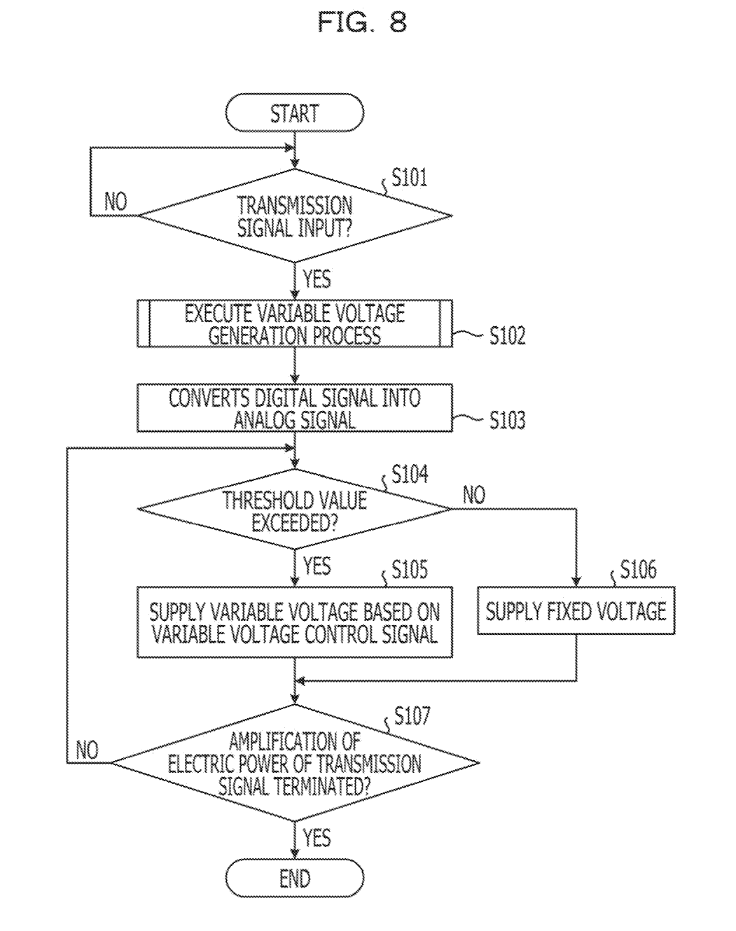

FIG. 8 is a flowchart illustrating a procedure of a process performed by the power supply circuit 100 according to the second embodiment. As shown in FIG. 8, when a transmission signal is supplied to the power supply circuit 100 (that is, when a determination is affirmative in operation S101), the digital processor 200 executes a digital variable voltage generation process in operation S102. Then, the DAC 110 converts the digital signal into an analog signal in operation S103. The DAC 110 converts a variable voltage control signal generated by the digital processor 200 into a voltage. The power supply circuit 100 is in a waiting state (that is, the determination is negative in operation S101) until the transmission signal is input.

The power supply circuit 100 determines whether a voltage corresponding to a peak of the transmission signal is larger than a threshold value in operation S104. When the determination is affirmative in operation S104, the FET 144b performs control so that a variable voltage output from the variable voltage source 120 is supplied to the HPA 170 in accordance with the variable voltage control signal in operation S105.

On the other hand, when the determination is negative in operation S104, the FET 144a performs control so that a fixed voltage output from the fixed voltage source 130 is supplied to the HPA 170 in operation S106. The power supply circuit 100 determines whether amplification of an electric power of the transmission signal has been terminated in operation S107. When the determination is negative in operation S107, the power supply circuit 100 returns to operation S104 where it is determined whether the voltage corresponding to the peak of the transmission signal is larger than the threshold value. On the other hand, when the determination is affirmative in operation S107, the power supply circuit 100 terminates this process.

Procedure of Process Performed by Digital Processor of Power Supply Circuit of Second Embodiment

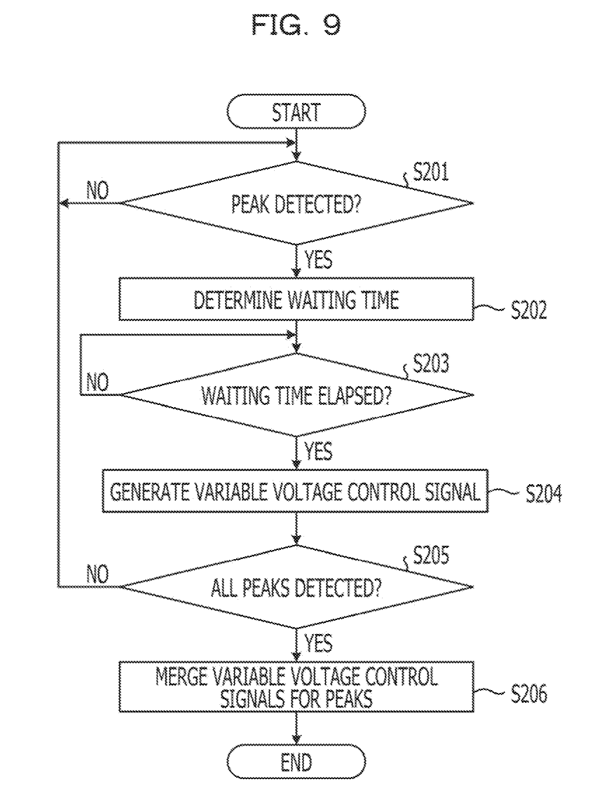

FIG. 9 is a flowchart illustrating a procedure of a process of generating a variable voltage performed by the digital processor 200 of the power supply circuit 100 according to the second embodiment. As shown in FIG. 9, when the peak detector 210 detects a peak (that is, when a determination is affirmative in operation S201), the waiting time conversion unit 240 determines a waiting time in operation S202. For example, the waiting time conversion unit 240 determines a waiting time which is a period of time required for generating a variable voltage for the peak detected by the peak detector 210 in accordance with a value of the peak detected by the peak detector 210 and a through rate of the variable voltage source 120. The digital processor 200 is in a waiting state (that is, the determination is negative in operation S201 until the peak is detected).

The signal generation unit 262 determines whether the waiting time determined by the waiting time conversion unit 240 has been elapsed in operation S203. When the determination is affirmative in operation S203, the signal generation unit 262 generates a variable voltage control signal in operation S204. For example, the signal generation unit 262 generates a rising variable voltage control signal after the waiting time has been elapsed. Then, the signal generation unit 262 generates a falling variable voltage control signal after half of the largest peak processing time has been elapsed. The signal generation unit 262 is in a waiting state (that is, the determination is negative in operation S203) until the waiting time has been elapsed.

The digital processor 200 determines whether all peaks included in the transmission signal have been detected in operation S205. When the determination is negative, the process returns to operation S201 where it is determined whether the peak detector 210 detects a peak. On the other hand, when the determination is affirmative in operation S205, the signal merging unit 270 merges variable voltage control signals corresponding to the peaks in operation S206 so as to obtain a single signal, and this process is terminated.

Effect of Second Embodiment

As described above, according to the second embodiment, the peak detector 210 detects a peak of a transmission signal. The waiting time conversion unit 240 determines a timing when a change of a variable voltage corresponding to the peak is started in accordance with a voltage value corresponding to the peak of the transmission signal detected by the peak detector 210 and a change rate of a variable voltage output from the variable voltage source 120. The signal generation unit 262 generates a variable voltage control signal used to start a change of a voltage at the timing determined by the waiting time conversion unit 240. The variable voltage source 120 outputs a voltage in response to the variable voltage control signal generated by the signal generation unit 262. Accordingly, the power supply circuit 100 according to the second embodiment supplies a voltage corresponding to a peak of the transmission signal to the HPA 170 and efficiently reduces power consumption.

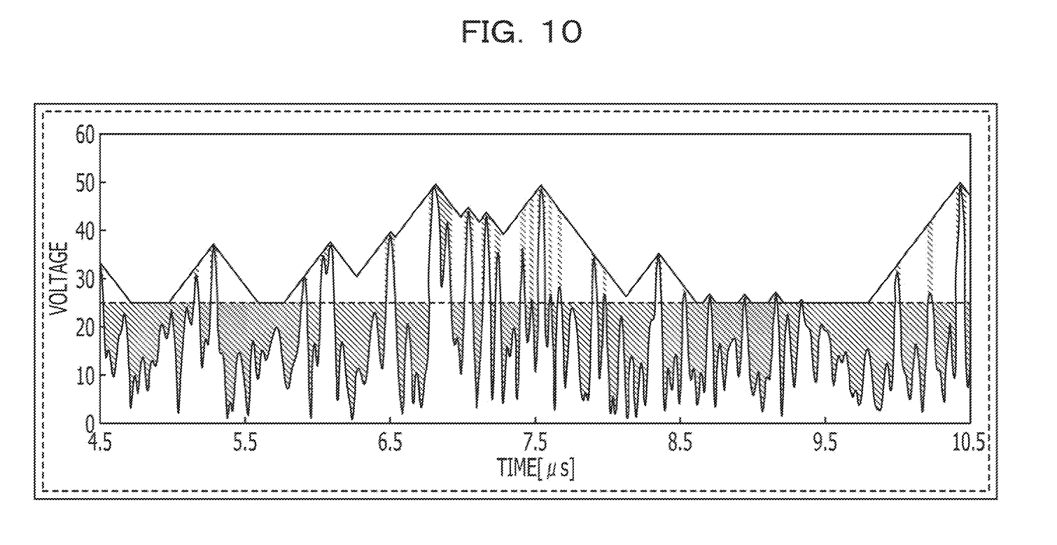

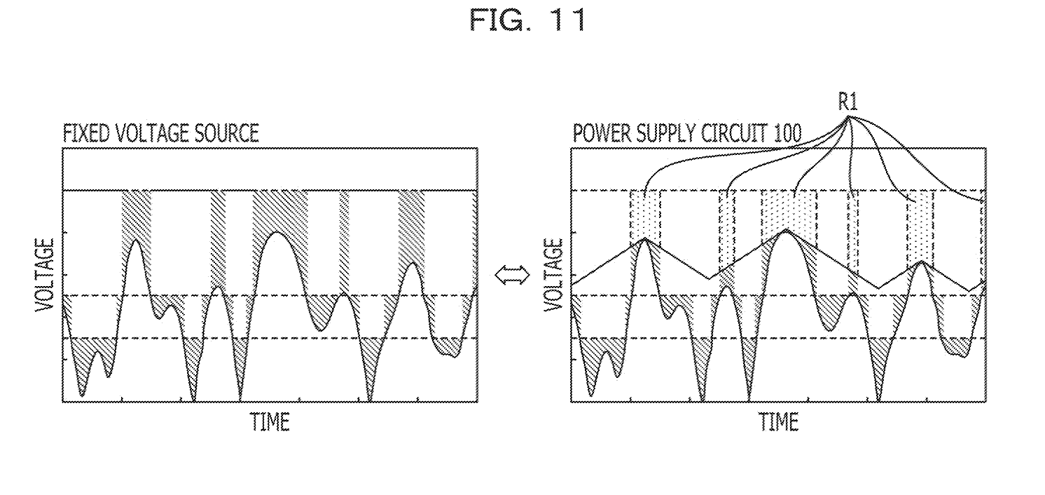

Power consumption of the power supply circuit 100 according to the second embodiment will be described with reference to FIGS. 10 and 11. FIG. 10 is a diagram illustrating a result of simulation performed by the power supply circuit 100 according to the second embodiment. In FIG. 10, an axis of ordinate denotes a voltage and an axis of abscissa denotes time. FIG. 10 shows losses of electric powers generated when a transmission signal is amplified by supplying a variable voltage to an envelope of the transmission signal. A bold line shown in FIG. 10 represents a variable voltage control signal. The shaded regions shown in FIG. 10 represent losses of electric powers. FIG. 10 shows a case where a variable voltage is supplied in accordance with peaks corresponding to voltages equal to or larger than 25 V as an example.

The variable voltage source 120 of the power supply circuit 100 according to the second embodiment changes and outputs a voltage in accordance with the variable voltage control signal shown in FIG. 10. The fixed voltage source 130 of the power supply circuit 100 according to the second embodiment outputs a fixed voltage of 25 V. The power supply circuit 100 according to the second embodiment switches a fixed voltage to a variable voltage when a peak of the transmission signal exceeds 25 V by switching the FETs 144a and the FET 144b in accordance with an electric power switching signal generated by the threshold value detector 290. Furthermore, the power supply circuit 100 according to the second embodiment switches the variable voltage to the fixed voltage when a peak of the transmission signal becomes smaller than 25 V by switching the FETs 144a and 144b in accordance with an electric power switching signal generated by the threshold value detector 290.

That is, the variable voltage source 120 of the power supply circuit 100 according to the second embodiment supplies to the HPA 170 the variable voltage obtained in accordance with the variable voltage control signal obtained in a period from when the peak of the transmission signal exceeds 25 V to when the peak of the transmission signal becomes smaller than 25 V. For example, as shown in FIG. 10, the power supply circuit 100 according to the second embodiment supplies a variable voltage corresponding to a peak larger than 25 V.

FIG. 11 is a diagram illustrating reduction of power consumed by the power supply circuit 100 according to the second embodiment. FIG. 11 shows a comparison of a loss of an electric power generated when a power supply circuit only employing a fixed voltage source amplifies a transmission signal with a loss of an electric power generated when the power supply circuit 100 of the second embodiment amplifies a transmission signal. In FIG. 11, axes of ordinate denote a voltage and axes of abscissa denote time. The shaded regions shown in FIG. 11 represent losses of electric powers.

As represented by “fixed voltage source” in FIG. 11, the power supply circuit only employing the fixed voltage source generates losses corresponding to electric powers excessively supplied when a fixed voltage corresponding to a peak of a transmission signal is high. On the other hand, as represented by “power supply circuit 100” in FIG. 11, the power supply circuit 100 of the second embodiment supplies a variable voltage in accordance with a peak, and accordingly, losses of electric powers in regions R1 are suppressed when compared with the fixed voltage source. That is, the power supply circuit 100 according to the second embodiment efficiently reduces power consumption.

Furthermore, the power supply circuit 100 of the second embodiment accepts various peaks using the fixed voltage source and the variable voltage source, and suppresses expansion of an area of the apparatus when compared with a power supply apparatus including a plurality of fixed voltage sources.

### Third Embodiment

The second embodiment described above shows a case where a single variable voltage control signal is generated for all peaks larger than the lowest voltage of the variable voltage source as an example. However, in a third embodiment, a case where a plurality of variable voltage control signals are generated depending on levels of values of peaks equal to or larger than the lowest voltage of a variable voltage source is described as an example.

Configuration of Power Supply Circuit of Third Embodiment

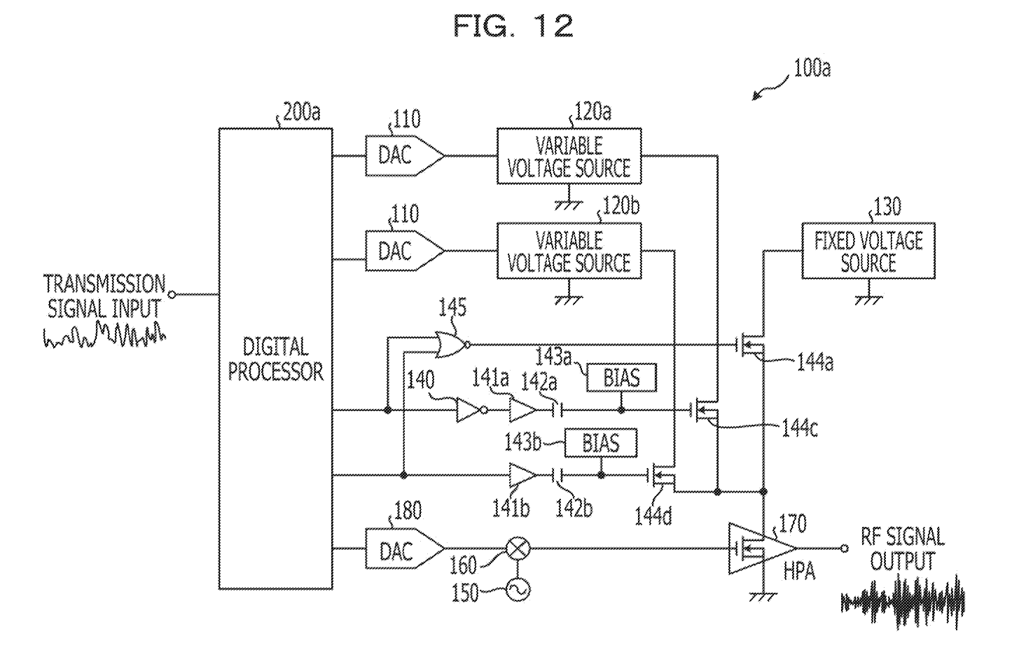

First, a configuration of a power supply circuit according to a third embodiment will be described. FIG. 12 is a diagram illustrating a power supply circuit 100a according to the third embodiment. The power supply circuit 100a of the third embodiment is different from the power supply circuit 100 of the second embodiment in that the power supply circuit 100a includes two DACs 110 as shown in FIG. 12. Furthermore, the power supply circuit 100a of the third embodiment is different from the power supply circuit 100 of the second embodiment in that the power supply circuit 100a includes variable voltage sources 120a and 120b as shown in FIG. 12. Furthermore, the power supply circuit 100a of the third embodiment is different from the power supply circuit 100 of the second embodiment in that the power supply circuit 100a includes FETs 144c and 144d as shown in FIG. 12. Moreover, the power supply circuit 100a of the third embodiment is different from the power supply circuit 100 of the second embodiment in that the power supply circuit 100a includes a NOR (Not OR) circuit 145 as shown in FIG. 12. Moreover, the power supply circuit 100a of the third embodiment is different from the power supply circuit 100 of the second embodiment in that content of a process performed by a digital processor 200a is different from that of the digital processor 200 of the second embodiment. Hereinafter, these different points will be mainly described.

The two DACs 110 convert different variable voltage control signals generated by the digital processor 200a which will be described hereinafter into analog signals. The variable voltage control signals supplied to the two DACs 110 will be described hereinafter. The variable voltage sources 120a and 120b output respective variable voltages in accordance with the variable voltage control signals generated by the digital processor 200a. The variable voltages output from the variable voltage sources 120a and 120b will be described hereinafter. The lowest voltages output from the variable voltage sources 120a and 120b are the same as each other and the highest voltages output from the variable voltage sources 120a and 120b are the same as each other.

The FET 144c controls supply of a voltage output from the variable voltage source 120a to a HPA 170 in accordance with a switching signal generated by the digital processor 200a. The FET 144d controls supply of a voltage output from the variable voltage source 120b to the HPA 170 in accordance with a switching signal generated by the digital processor 200a.

The NOR circuit 145 outputs a signal used to control supply of a fixed voltage by the FET 144a in accordance with the switching signals supplied to the FETs 144c and 144d. For example, when the switching signals supplied to the FETs 144c and 144d represent that a variable voltage is not to be supplied, the NOR circuit 145 outputs a signal used to perform control such that a fixed voltage output from a fixed voltage source 130 is supplied to the HPA 170 using an FET 144a.

Configuration of Digital Processor of Power Supply Circuit of Third Embodiment

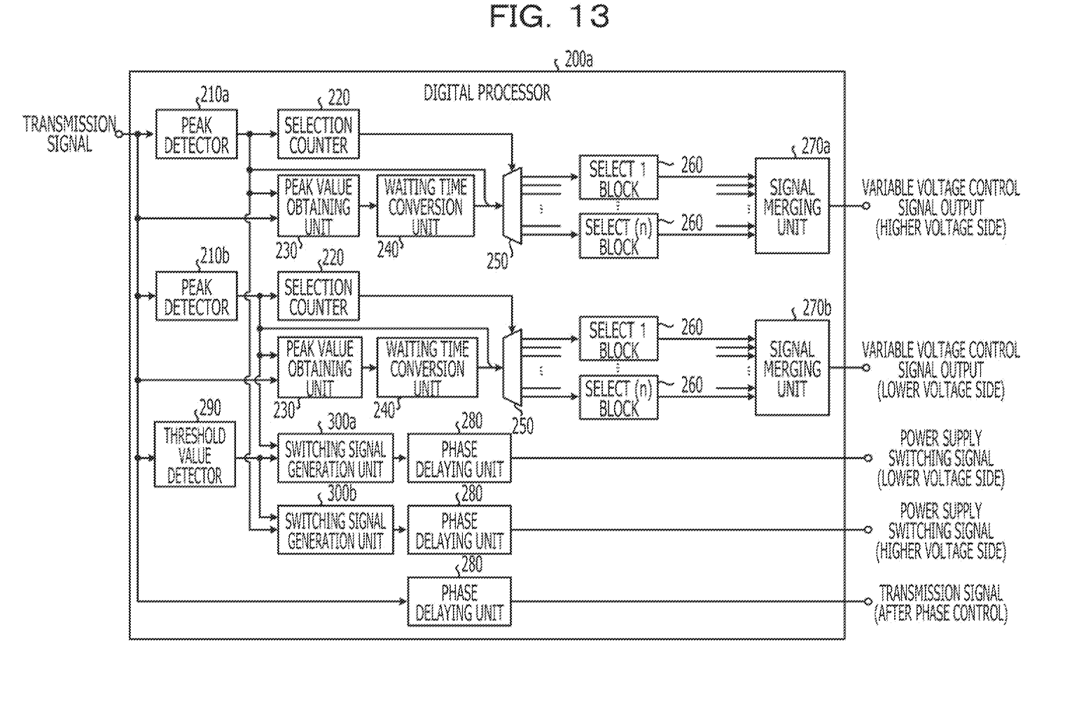

Next, a configuration of the digital processor 200a of the power supply circuit 100a according to a third embodiment will be described. FIG. 13 is a diagram illustrating a configuration of the digital processor 200a of the power supply circuit 100a according to the third embodiment. The digital processor 200a is different from the digital processor 200 of the power supply circuit 100 of the second embodiment in that the digital processor 200a includes peak detectors 210a and 210b as shown in FIG. 13. Furthermore, the digital processor 200a is different from the digital processor 200 in that the digital processor 200a includes two selection counters 220, two peak value obtaining units 230, two waiting time conversion units 240, and two selectors 250 as shown in FIG. 13.

Furthermore, the digital processor 200a is different from the digital processor 200 in that the digital processor 200a includes two groups of select1-block 260 to the select(n)-block 260 as shown in FIG. 13. Moreover, the digital processor 200a is different from the digital processor 200 in that the digital processor 200a includes signal merging units 270a and 270b as shown in FIG. 13. In addition, the digital processor 200a is different from the digital processor 200 in that the digital processor 200a includes switching signal generation units 300a and 300b as shown in FIG. 13. Furthermore, the digital processor 200a is different from the digital processor 200 in that the digital processor 200a includes three phase delaying units 280 as shown in FIG. 13. Hereinafter, these different points will be mainly described.

The peak detector 210a detects peaks equal to or larger than an arbitrary peak value among peaks of a transmission signal. For example, the peak detector 210a detects peaks in a range from the arbitrary peak value to a peak value corresponding to the highest voltage of the variable voltage source 120a. Specifically, the peak detector 210a detects peaks corresponding to voltages on a higher side in a range in which the variable voltage changes. The peak detector 210b detects peaks in a range from a peak value corresponding to the lowest voltage of the variable voltage source 120b to the arbitrary peak value. That is, the peak detector 210b detects peaks corresponding to voltages on a lower side in the range in which the variable voltage changes.

Each of the selection counters 220 increments a count number by 1 when receiving a signal representing that a peak is detected from a corresponding one of the peak detectors 210a or 210b. Each of the peak value obtaining units 230 obtains a value of the detected peak and stores the peak value when receiving the signal representing that the peak is detected from a corresponding one of the peak detectors 210a and 210b.

Each of the waiting time conversion units 240 determines a timing when a change of a voltage value is started for the corresponding one of the peaks detected by the peak detectors 210a and 210b. Specifically, the waiting time conversion unit 240 which determines a waiting time in accordance with a peak detected by the peak detector 210a determines a timing when a change of a variable voltage on a higher voltage side is started. Furthermore, the waiting time conversion unit 240 which determines a waiting time in accordance with a peak detected by the peak detector 210b determines a timing when a change of a variable voltage on a lower voltage side is started.

Signal generation units 262 generate variable voltage control signals for a plurality of peaks. The variable voltage control signals are used to start changes of voltages at timings determined by the waiting time conversion unit 240. Specifically, the signal generation units 262 included in the select1-block 260 to the select(n)-block 260 generates variable voltage control signals on a higher voltage side when the waiting times have been determined in accordance with the peaks detected by the peak detector 210a. Furthermore, the signal generation units 262 included in the select1-block 260 to the select(n)-block 260 generates variable voltage control signals on a lower voltage side when the waiting times have been determined in accordance with the peaks detected by the peak detector 210b.

The signal merging unit 270a merges the variable voltage control signals on the higher voltage side so as to obtain a single signal, and outputs the signal to the DAC 110 connected to the variable voltage source 120a. On the other hand, the signal merging unit 270b merges the variable voltage control signals on the lower voltage side so as to obtain a single signal, and outputs the signal to the DAC 110 connected to the variable voltage source 120b.

The switching signal generation unit 300a generates a switching signal used to supply a variable voltage on the lower voltage side in accordance with a power supply switching signal generated by the threshold value detector 290 and a signal representing that a peak is detected by the peak detector 210b. Specifically, the switching signal generation unit 300a generates a signal so as to instruct the FET 144d to supply a variable voltage on the lower voltage side output from the variable voltage source 120b to the HPA 170. The switching signal generation unit 300b generates a switching signal used to supply a variable voltage on the higher voltage side in accordance with a signal representing that a peak is detected by the peak detector 210a. Specifically, the switching signal generation unit 300b generates a signal so as to instruct the FET 144c to supply a variable voltage on the higher voltage side output from the variable voltage source 120a to the HPA 170.

The phase delaying unit 280 delays phases of the switching signal generated by the switching signal generation unit 300a, the switching signal generated by the switching signal generation unit 300b, and the transmission signal.

Hereinafter, a procedure of a process performed by the power supply circuit 100a according to the third embodiment will be described. First, a procedure of a process performed by the power supply circuit 100a according to the third embodiment will be described. Thereafter, a procedure of a process performed by the digital processor 200a of the power supply circuit 100a according to the third embodiment will be described.

Procedure of Process Performed by Power Supply Circuit of Third Embodiment

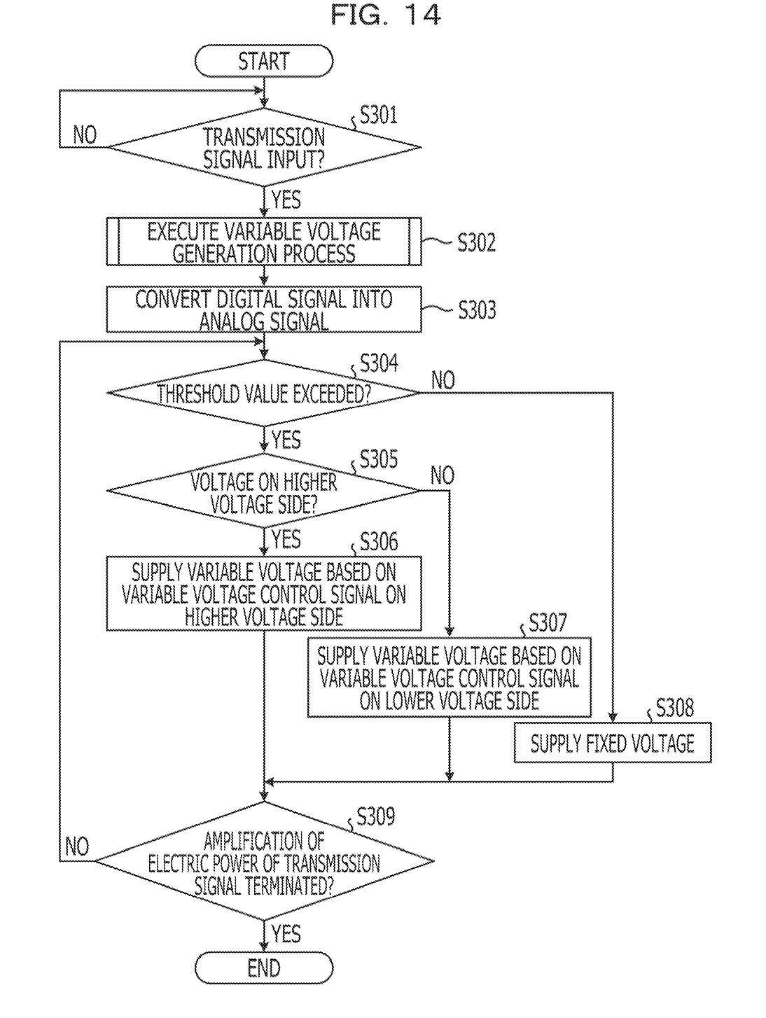

FIG. 14 is a flowchart illustrating a procedure of a process performed by the power supply circuit 100a according to the third embodiment. As shown in FIG. 14, When a transmission signal is supplied to the power supply circuit 100a (that is, when a determination is affirmative in operation S301), the digital processor 200a performs a variable voltage generation process in operation S302. Then, one of the DACs 110 coverts the digital signal into an analog signal in operation S303. The DACs 110 convert a variable voltage control signal on a higher voltage side or a variable voltage control signal on a lower voltage side generated by the digital processor 200a into a voltage. The power supply circuit 100 is in a waiting state (that is, the determination is negative in operation S301) until the power supply circuit 100 receives a transmission signal.

The power supply circuit 100a determines whether a voltage corresponding to a peak of the transmission signal is larger than a threshold value in operation S304. When the determination is affirmative in operation S304, the power supply circuit 100a determines whether the voltage corresponding to the peak of the transmission signal is a voltage on a higher voltage side in operation S305. When the determination is affirmative in operation S305, the FET 144c performs control so that a variable voltage output from the variable voltage source 120a in accordance with the variable voltage control signal on the higher voltage side is supplied to the HPA 170 in operation S306.

On the other hand, when the determination is negative in operation S305, the FET 144d performs control so that a variable voltage output from the variable voltage source 120b in accordance with the variable voltage control signal on the lower voltage side is supplied to the HPA 170 in operation S307. Note that when the determination is negative in operation S304, the FET 144a performs control so that a fixed voltage output from the fixed voltage source 130 is supplied to the HPA 170 in operation S308.

The power supply circuit 100a determines whether amplification of an electric power of the transmission signal is terminated in operation S309. When the determination is negative in operation S309, the power supply circuit 100a returns to operation S304 where it is determined whether the voltage corresponding to the peak of the transmission signal is larger than the threshold value. On the other hand, when the determination is affirmative in operation S309, the power supply circuit 100a terminates this process.

Procedure of Process Performed by Digital Processor of Power Supply Circuit of Third Embodiment

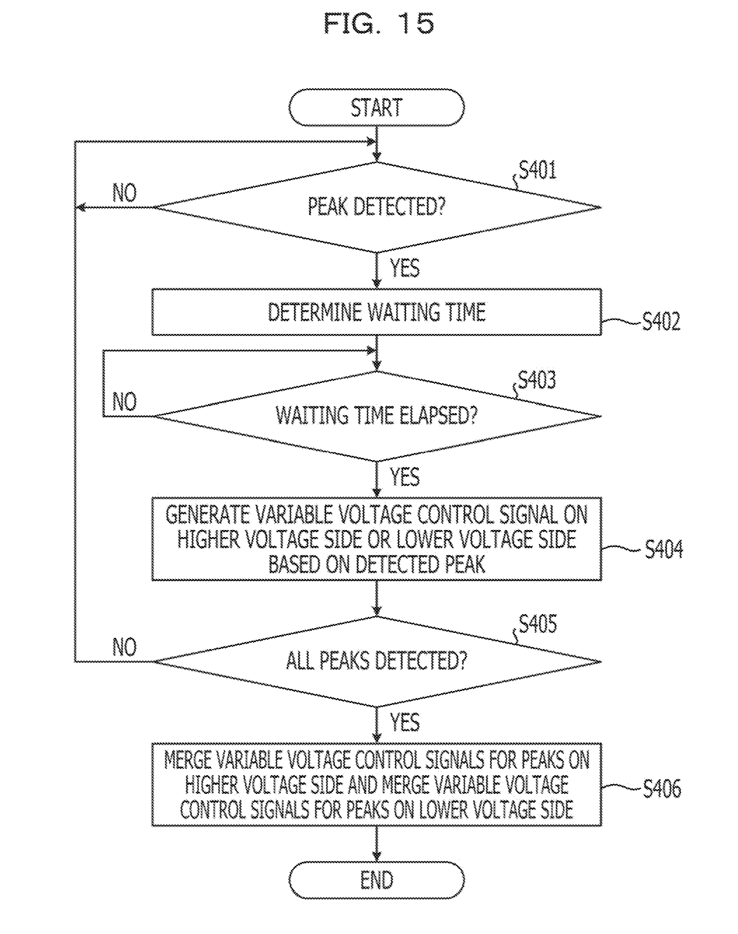

FIG. 15 is a flowchart illustrating a procedure of a variable voltage generation process performed by the digital processor 200a of the power supply circuit 100a according to the third embodiment. As shown in FIG. 15, when the peak detector 210a or the peak detector 210b detects a peak (that is, when a determination is affirmative in operation S401), the waiting time conversion unit 240 determines a waiting time in operation S402. For example, the waiting time conversion unit 240 determines a waiting time for generating a variable voltage for a peak detected by the peak detector 210a in accordance with a peak value detected by the peak detector 210a and a through rate of the variable voltage source 120a. Alternatively, the waiting time conversion unit 240 determines a waiting time for generating a variable voltage for a peak detected by the peak detector 210b in accordance with a peak value detected by the peak detector 210b and a through rate of the variable voltage source 120b. The digital processor 200a is in a waiting state (that is, the determination is negative in operation S403) until the waiting time has been elapsed.

The signal generation unit 262 determines whether the waiting time determined by the waiting time conversion unit 240 has been elapsed in operation S403. When the determination is affirmative in operation S403, the signal generation unit 262 generates a variable voltage control signal on a higher voltage side or a lower voltage side in operation S404. The signal generation unit 262 is in a waiting state until the waiting time has been elapsed (while the determination is negative in operation S403).

The digital processor 200a determines whether all peaks included in the transmission signal have been detected in operation S405. When the determination is negative in operation S405, the process returns to operation S401 where it is determined whether the peak detector 210a or the peak detector 210b detects a peak. On the other hand, when the determination is affirmative in operation S405, the signal merging unit 270a and the signal merging unit 270b merge variable voltage control signals on the higher voltage side and variable voltage control signals on the lower voltage side, respectively, in operation S406 so as to obtain respective signals. Then, this process is terminated.

Effect of Third Embodiment

As described above, according to the third embodiment, the waiting time conversion unit 240 determines timings when a change of a variable voltage is started for individual peaks detected by the peak detector 210a and the peak detector 210b. The signal generation unit 262 generates a variable voltage control signal used to start a change of a voltage at a timing determined by the waiting time conversion unit 240 for each peak. The variable voltage source 120a and the variable voltage source 120b output respective voltages in accordance with the variable voltage control signals generated by the signal generation unit 262. Accordingly, the power supply circuit 100a of the third embodiment supplies a voltage taking a level in a range of the variable voltage into consideration, and efficiently reduces power consumption.

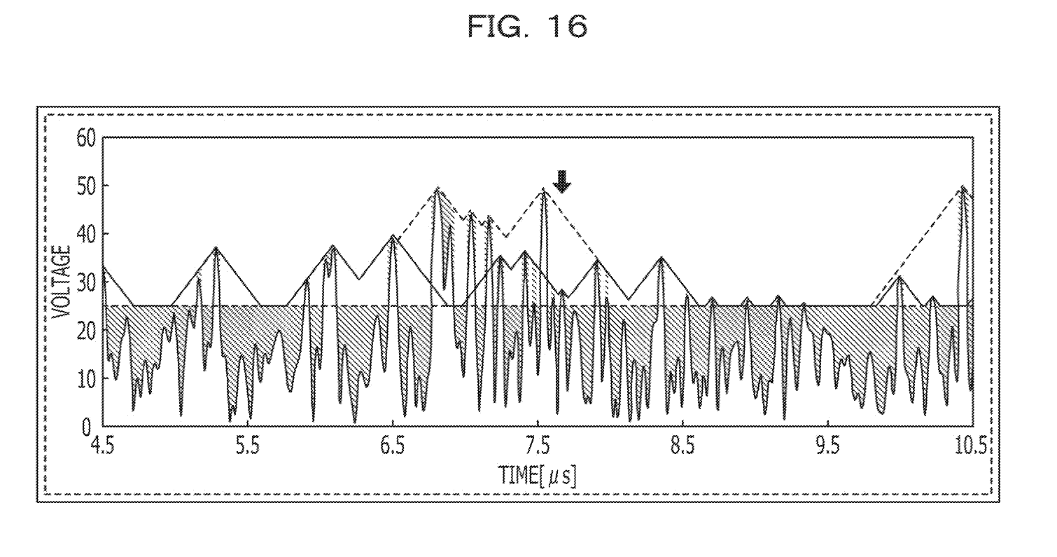

Referring now to FIG. 16, power consumption when the power supply circuit 100a according to the third embodiment is employed will be described. FIG. 16 is a diagram illustrating a result of simulation performed by the power supply circuit according to the third embodiment. In FIG. 16, an axis of ordinate denotes a voltage and an axis of abscissa denotes time. FIG. 16 shows losses of electric powers generated when a transmission signal is amplified by supplying a variable voltage to an envelope of the transmission signal. In FIG. 16, a bold line denotes a variable voltage control signal on a lower voltage side and a broken line denotes a variable voltage control signal on a higher voltage side. In FIG. 16, the shaded regions represent losses of electric powers. FIG. 16 shows a case where variable voltages are supplied to peaks corresponding to voltages equal to or larger than 25 V as an example. Furthermore, in FIG. 16, a variable voltage control signal on a lower voltage side is employed for peaks corresponding to voltages in a range from 25 V to 40V and a variable voltage control signal on a higher voltage side is employed for peaks corresponding to voltages in a range from 40 V to the highest voltage.

The variable voltage source 120a of the power supply circuit 100a according to the third embodiment outputs a voltage changed in accordance with a variable voltage control signal on a higher voltage side shown in FIG. 16. The variable voltage source 120b of the power supply circuit 100a according to the third embodiment outputs a voltage changed in accordance with a variable voltage control signal on a lower voltage side shown in FIG. 16. The power supply circuit 100a of the third embodiment switches a variable voltage on a lower voltage side to a variable voltage on a higher voltage side when a peak of the transmission signal exceeds 40 V by switching the FETs 144c and 144d in accordance with power supply switching signals generated by the switching signal generation units 300a and 300b. The power supply circuit 100a of the third embodiment switches a variable voltage on a higher voltage side to a variable voltage on a lower voltage side when a peak of the transmission signal becomes smaller than 40 V by switching the FETs 144c and 144d in accordance with power supply switching signals generated by the switching signal generation units 300a and 300b.

Accordingly, as denoted by an arrow mark shown in FIG. 16, even when a low peak appears immediately after a high peak of the transmission signal, the power supply circuit 100a of the third embodiment switches a variable voltage on a higher voltage side to a variable voltage on a lower voltage side so as to suppress losses of electric powers. Specifically, the power supply circuit 100a of the third embodiment supplies a voltage obtained taking a level in a range of a variable voltage into consideration, and efficiently reduces power consumption.

### Fourth Embodiment

In the second and third embodiments, the cases where variable voltage control signals are generated for all peaks corresponding to voltages equal to or larger than the lowest voltage of the variable voltage source are described as examples. In a fourth embodiment, a case where a peak for generating a variable voltage control signal is selected in accordance with a position of the peak of a transmission signal will be described.

Configuration of Digital Processor of Power Supply Circuit of Fourth Embodiment

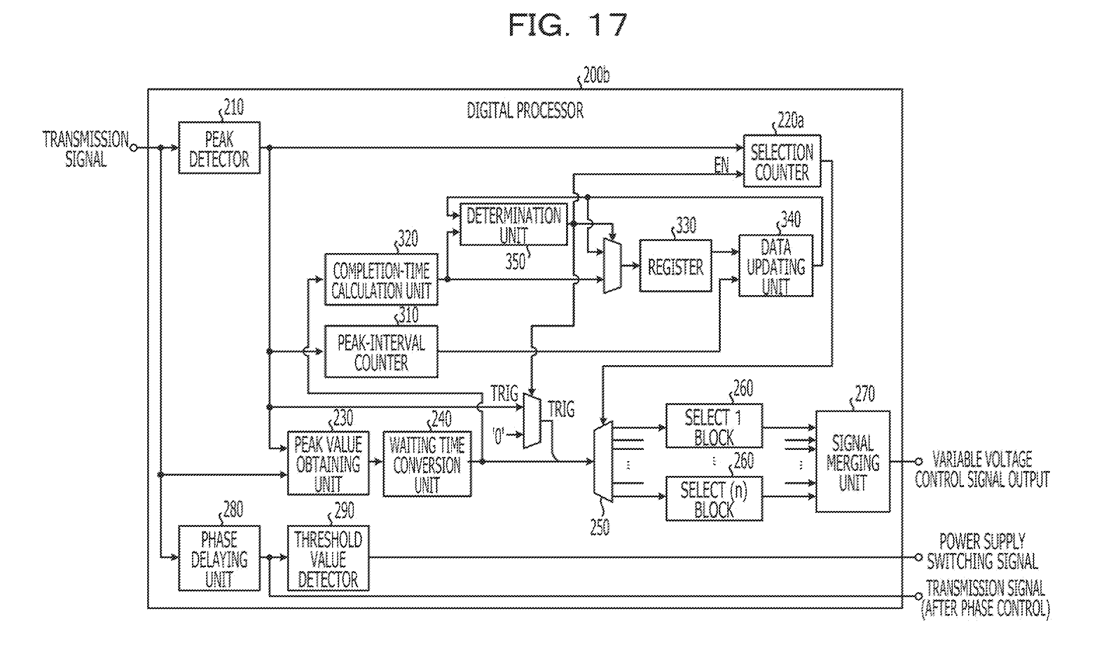

A configuration of a digital processor 200b of a power supply circuit according to the fourth embodiment will be described. FIG. 17 is a diagram illustrating a configuration of the digital processor 200b of the power supply circuit according to the fourth embodiment. The digital processor 200b is different form the digital processor 200 of the power supply circuit 100 according to the second embodiment in that the digital processor 200b includes a peak-interval counter 310, a completion-time calculation unit 320, and a register 330 as shown in FIG. 17. Furthermore, the digital processor 200b is different from the digital processor 200 of the power supply circuit 100 according to the second embodiment in that the digital processor 200b includes a data updating unit 340 and a determination unit 350 as shown in FIG. 17. Moreover, the digital processor 200b is different from the digital processor 200 of the power supply circuit 100 according to the second embodiment in that content of a process performed by a selection counter 220a is different from content of the process performed by the selection counter 220. Hereinafter, these different points will be mainly described.

The peak-interval counter 310 measures an interval between peaks. The completion-time calculation unit 320 determines a timing when a change of a variable voltage for a peak of a transmission signal is terminated in accordance with a voltage value corresponding to the peak and a change rate of the variable voltage output from the apparatus. For example, the completion-time calculation unit 320 calculates a completion time for each peak by subtracting a waiting time determined by the waiting time conversion unit 240 from the largest peak processing time. The completion time corresponds to a period of time in which a variable voltage control signal is completely generated.

The register 330 stores the completion time calculated by the completion-time calculation unit 320. The data updating unit 340 subtracts an interval between peaks measured by the peak-interval counter 310 from the completion time stored in the register 330. The determination unit 350 determines whether a period of time from when a peak is detected to when a change of a variable voltage is terminated is included in an interval between the peak and a preceding peak. For example, the determination unit 350 compares a completion time of a current peak calculated by the completion-time calculation unit 320 with a completion time of a preceding peak supplied from the data updating unit 340 to determine whether the completion time of the current peak is smaller than the completion time of the preceding peak.

Since the data updating unit 340 performs the subtraction of the interval between the peaks, a shift of the completion time of the preceding peak has been corrected. When the determination unit 350 determines that the completion time of the current peak is not smaller than the completion time of the preceding peak, the selection counter 220a increments a count number by 1.

Specifically, the selector 250 supplies waiting times to the select1-block 260 to the select(n)-block 260 only when a completion time of a current peak is longer than a completion time of a preceding peak. As shown in FIG. 17, a result of the determination performed by the determination unit 350 controls a supply of a trigger to the counters 261 included in the select1-block 260 to the select(n)-block 260. Specifically, the trigger is supplied to the counters 261 only when the completion time of the current peak is longer than the completion time of the preceding peak.

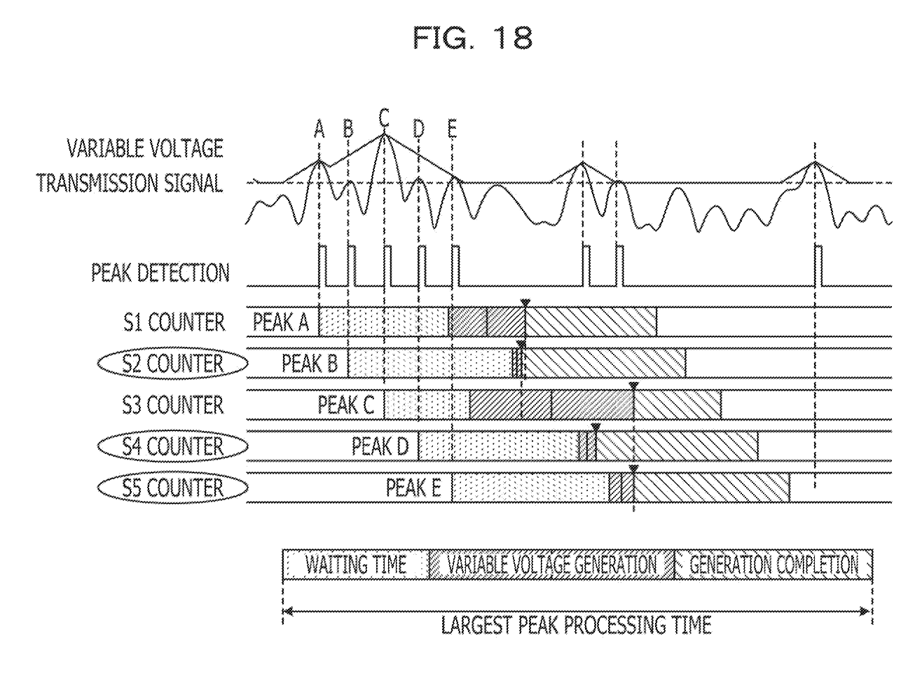

FIG. 18 is a timing chart illustrating the digital processor of the power supply circuit according to the fourth embodiment. In FIG. 18, an axis of abscissa denotes time. In FIG. 18, “variable voltage” represents a variable voltage control signal which corresponds to a transmission signal and which is generated by the digital processor 200b of the power supply circuit according to the fourth embodiment. Furthermore, “transmission signal” denotes a data signal supplied to the digital processor 200b, “peak detector” denotes a peak detector 210, and “S1 counter” to “S5 counter” denote the counters 261 included in the select1-block 260 to the select5-block 260.

Each of the largest peak processing times measured by the S1 counter to the S5 counter includes a waiting time, a period of time required for generating a variable voltage control signal (hereinafter referred to as a “variable voltage generation time”), and a period of time from when a variable voltage control signal is generated to when the largest peak processing time is terminated (hereinafter referred to as a “generation completion time”). As shown in FIG. 18, when the peak detector 210 detects a peak A, a waiting time is determined and a completion time is calculated. The completion time is obtained by adding the waiting time and the variable voltage generation time to each other.

After the peak detector 210 detects a peak B, a waiting time is determined, and a completion time is calculated, the determination unit 350 compares the completion time of the peak A with the completion time of the peak B. As shown in FIG. 18, since the completion time of the peak B is shorter than the completion time of the peak A, the digital processor 200b of the power supply circuit according to the fourth embodiment skips a process of generating a variable voltage control signal for the peak B, that is, the digital processor 200b does not generate the variable voltage control signal for the peak B.

Similarly, after the peak detector 210 detects peaks C to E, waiting times are determined, and completion times are calculated, the determination unit 350 successively compares the completion times to one another. As shown in FIG. 18, since the completion times of the peaks D and E are shorter than that of the peak C, the digital processor 200b of the power supply circuit according to the fourth embodiment skips a process of generating a variable voltage control signal for the peak D and a process of generating a variable voltage control signal for the peak E, that is, the digital processor 200b does not generate variable voltage control signals for the peaks D and E.

Accordingly, the digital processor 200b according to the fourth embodiment does not perform the processes of generating variable voltage control signals on the peaks B, D, and E so that efficient use of a circuit for generating a variable voltage control signal is attained.

Procedure of Process Performed by Digital Processor of Power Supply Circuit of Fourth Embodiment

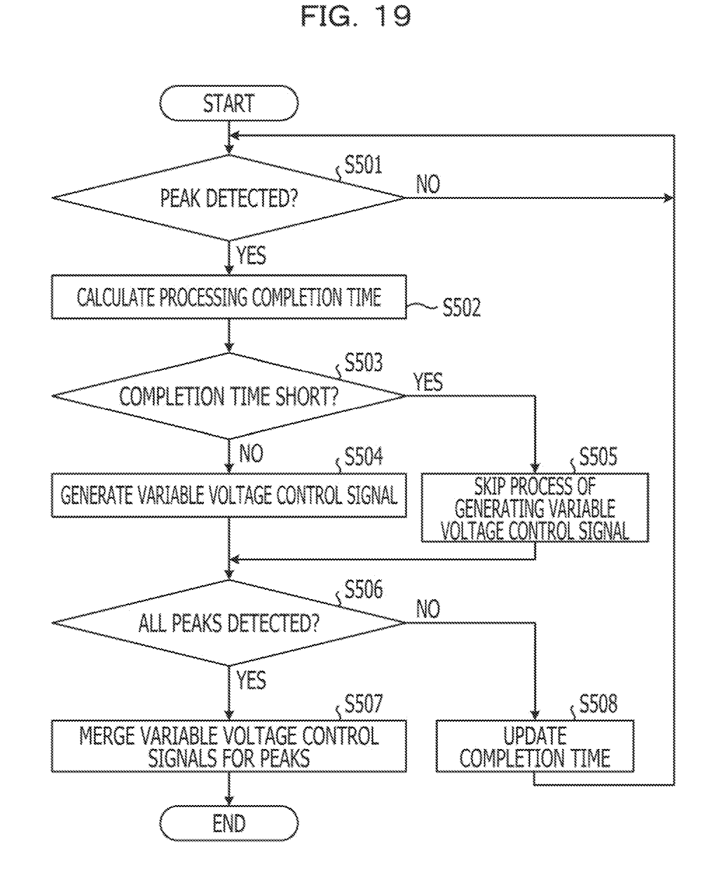

Next, a procedure of a process performed by the digital processor 200b of the power supply circuit according to the fourth embodiment will be described. FIG. 19 is a flowchart illustrating a procedure of a variable voltage generation process performed by the digital processor 200b of the power supply circuit according to the fourth embodiment. As shown in FIG. 19, when the peak detector 210 detects a peak (that is, when a determination is affirmative in operation S501), the completion-time calculation unit 320 calculates a completion time in operation S502. For example, the completion-time calculation unit 320 subtracts a waiting time determined by the waiting time conversion unit 240 from the largest peak processing time. The digital processor 200b is in a waiting state (that is, the determination is negative in operation S501) until a peak is detected.

The determination unit 350 determines whether the completion time of the current peak is shorter than a completion time of a preceding peak in operation S503. When the determination is negative in operation S503, the signal generation unit 262 generates a variable voltage control signal for the current peak in operation S504.

On the other hand, when the determination is affirmative in operation S503, the digital processor 200b skips a process of generating a variable voltage control signal for the current peak, that is, the digital processor 200b does not generate a variable voltage control signal in operation S505. The digital processor 200b determines whether all peaks included in the transmission signal have been detected in operation S506.

When the determination is negative in operation S506, a completion time of the register 330 and a completion time of the data updating unit 340 are updated in operation S508, and it is determined whether the peak detector 210 detected a peak in operation S501. On the other hand, when the determination is affirmative in operation S506, the signal merging unit 270 merges variable voltage control signals of the peaks in operation S507 so as to obtain a single signal and this process is terminated.

Effect of Fourth Embodiment

As described above, according to the fourth embodiment, the completion-time calculation unit 320 determines a timing when a change of a variable voltage for a target peak is terminated in accordance with a voltage value for the peak of the transmission signal detected by the peak detector 210 and a change rate of the variable voltage output from the apparatus. The signal generation unit 262 generates a variable voltage control signal provided that a period of time from when the peak detector 210 detects the peak to when the change of the variable voltage detected by the completion-time calculation unit 320 is terminated is not included in a period of time corresponding to an interval between the target peak and a preceding peak. Accordingly, the power supply circuit 100b of the fourth embodiment eliminates a process of generating a variable voltage control signal performed when a low peak appears immediately after a high peak in a transmission signal which is an unnecessary process and efficiently uses a variable voltage control signal generation circuit.

### Fifth Embodiment

The first to fourth embodiments have been described above. However, various embodiments may be made other than these embodiments. The various embodiments will be described in sections (1) to (3) below.

(1) Modification

In the third embodiment, the case where two variable voltage sources having the same lowest voltages and the same highest voltages are used has been described as an example. However, this embodiment is not limited to this. For example, two variable voltage sources having different lowest voltages and different highest voltages may be used.

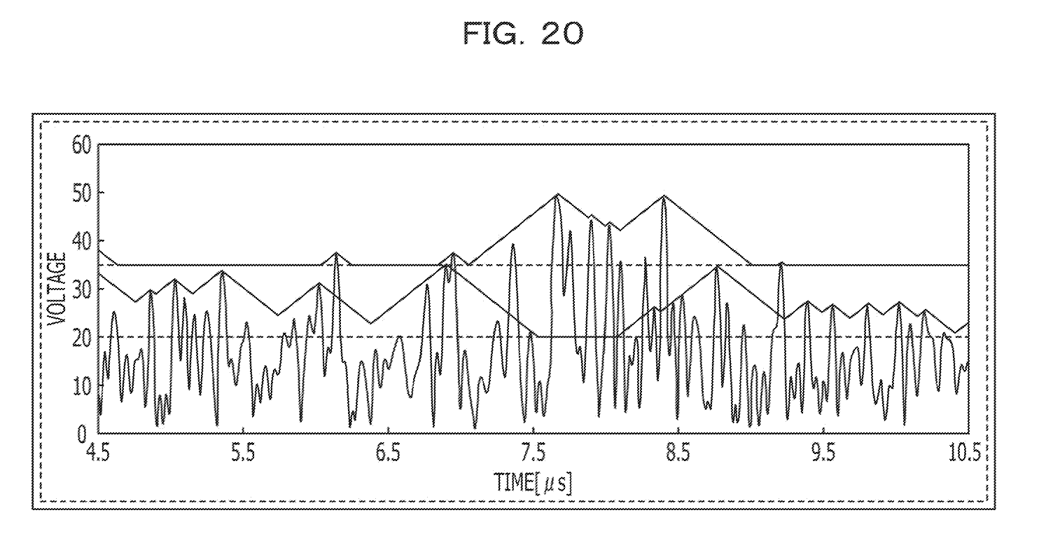

FIG. 20 is a diagram illustrating the modification. In FIG. 20, an axis of ordinate denotes a voltage and an axis of abscissa denotes time. FIG. 20 shows an example in which two variable voltage control signals are generated for an envelope of a transmission signal. In FIG. 20, bold lines denote variable voltage control signals. FIG. 20 shows a case where variable voltages are supplied for peaks corresponding to voltages equal to or larger than 20 V as an example.

A power supply apparatus in this embodiment may employs a variable voltage source in which the lowest voltage is 20 V and the highest voltage is 35 V and a variable voltage source in which the lowest voltage is 35 V, as shown in FIG. 20 and generates variable voltage control signals in the ranges.

(2) Variable Voltage Source

In the third embodiment described above, a case where two variable voltage sources are employed has been described. However, this embodiment is not limited to this. For example, in this embodiment, three or more variable voltage sources may be employed.

(3) System Configuration

The components of the apparatuses shown in the drawings are conceptual functions, and therefore, physical components are not required to be identical with the components shown in the drawings. That is, concrete configurations of division and integration in each of the apparatuses are not limited to those shown in the drawings, and all or part of each of the apparatuses may be functionally or physically divided or integrated in an arbitrary unit depending on various loads, usage states, and the like. For example, the peak detector 210a and the peak detector 210b shown in FIG. 13 may be integrated with each other as a single peak detector. For example, the threshold value detector 290 shown in FIG. 4 may be divided into a determination unit which determines whether a threshold value is exceeded and a signal generation unit which generates a power supply switching signal.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A power supply apparatus comprising:
a detector configured to detect a peak of a transmission signal;
a determination unit configured to determine a start timing based on a voltage value corresponding to the peak and a change rate of the variable voltage output from the apparatus, the start timing is a timing when a change of a variable voltage corresponding to the peak is started;
a generation unit configured to generate a variable voltage control signal used to start the change of the voltage at the start timing; and
an output unit configured to output a voltage based on the variable voltage control signal.

2. The power supply apparatus according to claim 1, wherein
the detector detects a plurality of peaks of the transmission signal,
the determination unit determines respective start timings when changes of variable voltages are started for the peaks,
the generation unit generates variable voltage control signals used to start the changes of the voltages for the peaks at the start timings, and
the output unit outputs a voltage based on the variable voltage control signals.

3. The power supply apparatus according to claim 1, wherein
the determination unit determines an end timing based on the voltage value corresponding to the peak and the change rate of the variable voltage output from the apparatus, the end timing is a timing when the change of the variable voltage corresponding to the peak is terminated, and
the generation unit generates the variable voltage control signal when a period of time from when the peak is detected by the detector to when the end timing determined by the determination unit has been reached is not included in a period for a preceding peak.

4. A power supply control method comprising:
detecting a peak of a transmission signal;
determining a start timing based on a voltage value corresponding to the peak and a change rate of the variable voltage output from the apparatus, the start timing is a timing when a change of a variable voltage corresponding to the peak is started;
generating a variable voltage control signal used to start the change of the voltage at the start timing; and
outputting a voltage based on the variable voltage control signal.

5. The power supply control method according to claim 4, wherein
the detecting detects a plurality of peaks of the transmission signal,
the determining determines respective start timings when changes of variable voltages are started for the peaks,
the generating generates variable voltage control signals used to start the changes of the voltages for the peaks at the start timings, and
the outputting outputs a voltage based on the variable voltage control signals.

6. The power supply control method according to claim 4, wherein
the determining determines an end timing based on the voltage value corresponding to the peak and the change rate of the variable voltage output from the apparatus, the end timing is a timing when the change of the variable voltage corresponding to the peak is terminated, and
the generating generates the variable voltage control signal when a period of time from when the peak is detected by the detecting to when the end timing determined by the determining has been reached is not included in a period for a preceding peak.
